(19) United States
(12) Patent Application Publication
(10) Pub. No.: US 2005/0062970 A1
(43) Pub. Date: Mar. 24, 2005

(54) Dental colorimetry measuring apparatus

(76) Inventors: Jean-Pierre Delgrande, Boulogne-Billancourt (FR); Emile Chokron, Paris (FR)

Correspondence Address: YOUNG & THOMPSON, 745 SOUTH 23RD STREET, 2ND FLOOR, ARLINGTON, VA, 22202, US

(21) Appl. No.: 10/493,448

(22) PCT Filed: Oct. 24, 2002
(86) PCT No.: PCT/FR02/03663

(30) Foreign Application Priority Data
Oct. 24, 2001 (FR) 01/13760
Oct. 24, 2001 (FR) 01/13761

(51) Int. Cl. G01J 3/51

(52) U.S. Cl. 356/419

(57) ABSTRACT

The invention relates to a dental colorimetry measuring device including: a white light source, means enabling to project the luminous flux transmitted by the source on a tooth to be measured, means for collecting the flux diffused by said tooth, means of spectral selection of the flux diffused, means for measuring luminous fluxes selected spectrally, means for processing the result of these measures enabling classification of the tooth measured with respect to a chart of colour range. The device includes a transmission and reception set and a measuring head contacting the tooth to be measured, the measuring head being connected to the transmission and reception set by an optical fibre beam. The measuring head includes an electric switch triggered by the pressure of the head on the tooth and controls the measure.

The invention relates to a colorimetric analysis device usable for measuring the tone of a tooth.

It is known that one currently resorts to such a measure when realising a dental prosthesis.

The patent FR-2.768.513 having the same holders as this application relates to a comparative colorimetric analysis method and a corresponding device. One may advantageously refer thereto in order to know the context of this invention and a method to which the device of the present invention is particularly well suited.

Indeed, the implementation of the previous invention mentioned above has led to the development of the measuring device subject of this application.

The first object of this invention is the realisation of a device which enables the realisation of a measure under good conditions and breaks free from, in particular, spurious effects liable to be generated by the room light.

Another object of this invention is the realisation of a device whereof the use for the practician is particularly simple and which confers to the patient perfect hygienic conditions.

Another object of the invention is to enable the realisation of a dental colorimetry measuring device under optimised economic conditions.

To this end, the invention relates to a dental colorimetry measuring device including a white light source, means enabling to project the luminous flux transmitted by the source on a tooth to be measured, means for collecting the flux diffused by said tooth, means of spectral selection of the flux diffused, means for measuring luminous fluxes selected spectrally, means for processing the result of these measures enabling classification of the tooth measured with respect to a chart of colour range.

This device includes a transmission and reception set and a measuring head contacting the tooth to be measured, the measuring head being connected to the transmission and reception set by an optical fibre beam.

According to the invention, the measuring head includes an electric switch triggered by the pressure of the head on the tooth and controls of measure.

In preferred embodiments each having their specific advantage and liable to be combined, this dental colorimetry device includes the following characteristics:
the optical fibre beam includes a single collection fibre at least partially of large diameter surrounded with small diameter transmission fibres;
at the end of the measuring head contacting the tooth, the transmission fibres are recessed with respect to the collection fibre;
the measuring head is fitted with a single-use hygienic cap;
the optical fibre beam includes a single collection fibre at least partially of large diameter surrounded with small diameter transmission fibres;
the collection optical fibre includes a large diameter mixer-dispenser;
selection fibres are coupled to the mixer and collect fluxes intended respectively for a measure of luminance and for each spectral measure;
the spectral selection means are wide pass-band filters;
the filters are respectively yellow, blue, red and green;
the device includes calibration means measuring, for each measure of tooth, the fluxes selected spectrally according to the same law as that applied to the light diffused, directly by the source and the processing means make use of the spectral ratios composed, for each spectral selection, of the ratio of the measure of the flux diffused to that of the source;
the device includes means for assessing the luminosity including the measure of the luminosity of a gauge, the measure of the luminosity of the source when measuring the gauge, the measure of the luminosity of the tooth and the measure of the luminosity of the lamp when measuring the tooth;
the chart of colour range is an actual chart of colour range whereof each tone has been measured prior to the measure of the tooth;
the chart of colour range is a virtual chart of colour range.

The invention will be described more in detail with reference to the appended drawings wherein:

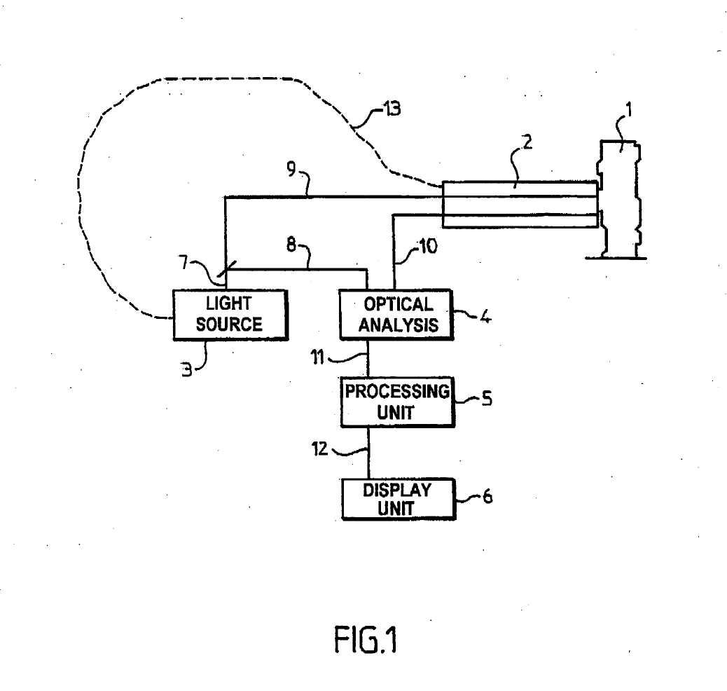

FIG. 1 is a general representation of the device object of the invention;

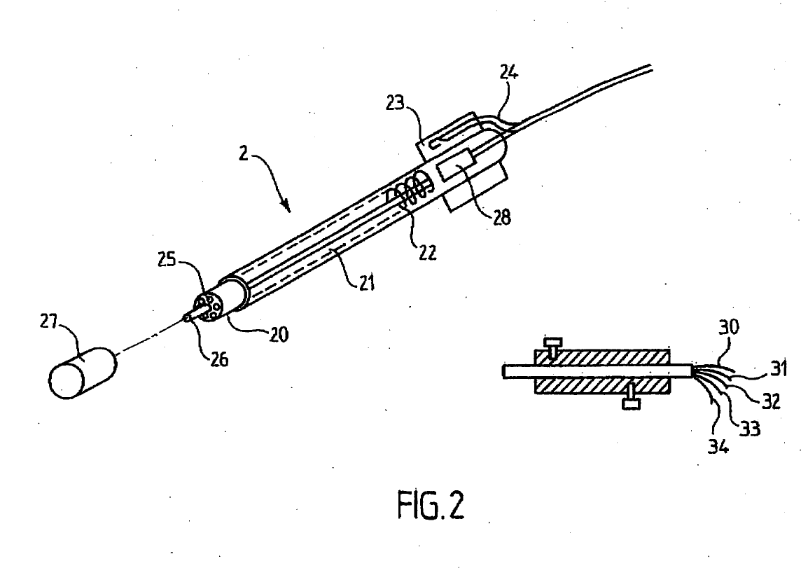

FIG. 2 is a schematic representation of the measuring head;

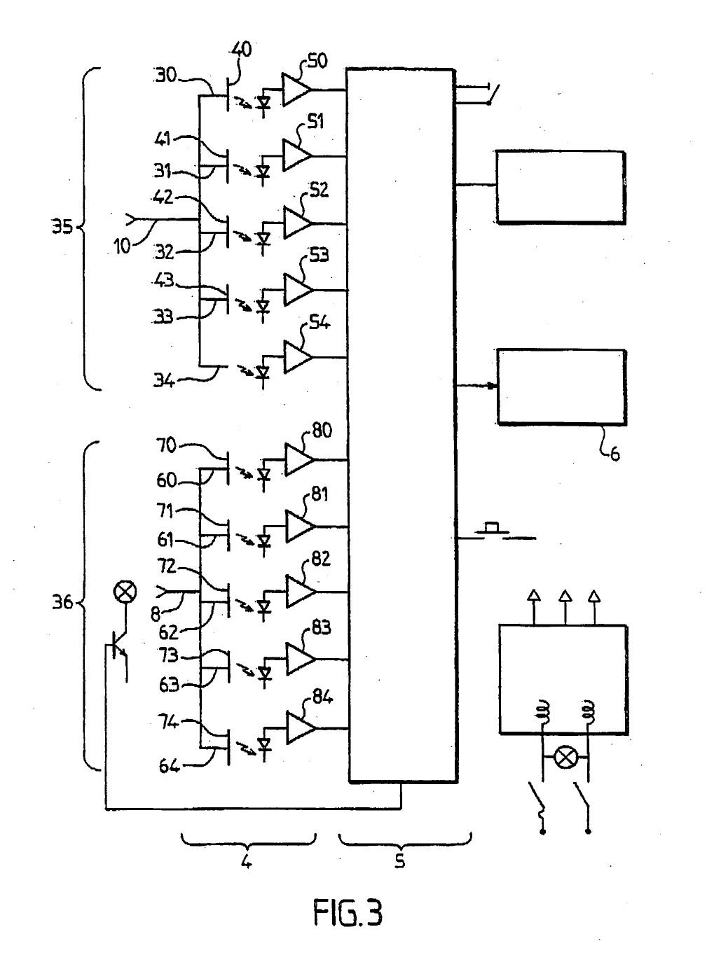

FIG. 3 is a representation of the electric principle of the device.

The tooth 1 to be measured is placed in contact with the measuring head 2 which power supplied by a light source 3 and generates a luminous flux diffused which is processed by the analyser 4 which provides the result of its analysis to a processing unit 5 and which, itself, by dint of the display unit 6, provides the classification of the tooth with respect to the chart of colour range.

The light transmitted by the source 3 is collected by a fibre beam 7 and a portion of this light energy is directly guided by the fibre beam 8 towards the optical analyser 4. Another portion of the flux of the source is transmitted by the fibre beam 9 to the measuring head 2 for the illumination of the tooth 1. The light diffused by the tooth 1 is collected by dint of the measuring head 2 through the fibre beam 10 and sent to the optical analyser 4. Electrical links II and 12 provide the links respectively between the optical analyser 4 and the processing unit 5 on the one hand, and between this processing unit 5 and the display unit 6 on the other hand.

An electrical link 13 connects the measuring head 2 to the light source 3 enabling to control the source according to modalities which will be described below using the measuring head 2.

The measuring head 2 is represented more accurately on FIG. 2. It includes a body 20 with respect to which a sheath 21 is mobile slidingly. A recall spring 22 determines the relative position at rest of the sheath 21 with respect to the body 20 and a contactor 23 actuated by the relative movement 21 with respect to the body 20 switches on the source 3 and thereby triggers the measure. To this end, the electric conductors 24 connect the contactor 23 to the source 3. Thus, the head includes an outer sheath and an inner body including the optical fibres, the sheath and the body being mobile in translation slidingly with respect to one another, in order to actuate an electric switch triggered by the pressure of the body on the tooth and to control the measure, a recall spring determining the position at rest of the sheath with respect to the body.

The body 20 caries transmission fibres 25 which illuminate the tooth 1 when measuring from the source 7. These transmission fibres 25 are connected to the source 3 via the fibre beam 9.

A central light collection fibre 26 collects the light diffused by the tooth 1 and sends it by dint of the fibre beam 10 to the optical analyser 4.

The ends of the transmission 25 and of collection 26 fibres are polished, which enables to optimise transmission of the light in either direction, between the tooth and the measuring head.

The central light reception fibre 26 is advantageously longer, contacting thus more closely the tooth than the transmission fibres.

To obtain good hygienic conditions, the measuring head 2 is fitted with a single-use cap 27 transparent which is the only element to contact the patient directly.

The collection fibre 26 is coupled to a mixer-dispenser 28 which is itself an optical element in the form of a fibre whose diameter is generally greater than that of the collection fibre 26.

This mixer-dispenser 28 is connected to five fibres (or fibre beams). Each of these fibres is intended for the measure, either of a colour 30 blue 31, red 32, green 33 or of the luminance or clarity 34. This mixer-dispenser 28 enables to obtain a homogeneous measure even if the tooth includes small local variations in its colour or in its tone.

FIG. 3 is a detailed representation of the optical analyser 4, the processing unit 5 and the display unit 6.

The optical analyser 4 is composed of two modules, the reading module 35 receiving the luminous flux diffused by the tooth measured through the beam 10 and the reference module 36 receiving the luminous flux coming directly from the source 3 via the fibre beam 8.

Each of these modules 35 and 36 performs processing cycles and comparable measures on the luminous flux received, the luminous flux transmitted by the fibre 30 is filtered by a yellow filter 42 and measured by a receiver 50. Similarly, the luminous flux transmitted by the fibre 31 is filtered by a blue filter 41 and measured by a receiver 51, the luminous flux transmitted by the fibre 32 is filtered by a red filter 42 and measured by a receiver 52, the luminous flux transmitted by the fibre 33 is filtered by a green filter 43 and measured by a receiver 53, the luminous flux transmitted by the fibre 34 is not filtered and its measure by a receiver 54 provides the measure of luminance of the flux diffused.

The same goes for the luminous flux coming from the source transmitted by the beam 8 which is divided on fibres 60, 61, 62, 63, 64 and, after possible filtration by the filters 70, 71, 72 and 73, is measured by the receivers 80, 81, 82, 83, 84 supplying respective measures of the yellow component, of the blue component, of the green component and of the clarity of the flux coming from the source.

The processing unit 5 performs ratios in order to assess the tone requested.

More precisely, this measure of the tone consists of two successive operations.

According to the first operation, after switching on the device, calibration is performed and which consists in measuring the tone and the luminosity of the gauge. This tales place by showing the tip of the measuring head on the gauge and by applying a small pressure.

A luminous flux is then sent to the gauge and the parameters are saved on memory:
Jc: value measured on the yellow filter
Bc: value measured on the blue filter
Rc: value measured on the red filter
Vc: value measured on the green filter
JLc: value measured on the yellow filter directly from the source during calibration.
BLc: value measured on the blue filter directly from the source during calibration
RLc: value measured on the red filter directly from the source during calibration.
VLc: value measured on the green filter directly from the source during calibration

The value Lc is the luminosity of the gauge, i.e. the value measured without filtering thereon.

The second operation consists in performing the measures on the tooth to be measured properly speaking and, comparatively, one obtains the measures:
Jd, Bd, Rd, Vd

One then considers the absolute measures for each colour as supplied by the following ratios:

| | |
|---|---|
| Yellow: | Jd/Jc × JLc/JLd |
| Blue: | Bd/Bc × BLc/BLd |
| Red: | Rd/Rc × VLc/VLd |
| Green: | Vd/Vc × VLc/VLd |

taking into account the calibration, one obtains the following ratios:

$$Yellow \text{/} blue : \frac{Jd \text{/} Jc}{Bd \text{/} Bc} \times \frac{JLc \text{/} JLd}{BLc \text{/} BLd}$$

$$Red \text{/} green : \frac{Rd \text{/} Rc}{Vd \text{/} Vc} \times \frac{RLc \text{/} RLd}{VLc \text{/} VLd}$$

One then assesses the luminosity of the tooth with respect to that of the gauge under analogous conditions:
Lc in the luminosity of the gauge
LLc in the luminosity of the lamp during calibration
Ld in the luminosity of the tooth when measuring the tooth
LLd in the luminosity of the tooth when measuring the tooth

The formula providing the luminosity of the tooth is defined as follows:
Luminosity=Ld/Lc×LLc/LLd

In an embodiment variation, the chart of colour range (or chart of tone range) is virtual and the colorimetric values are stored in an electronic support in the form of digital data, which may be selected and readable by the device of the invention. This chart of tone range may then be stored in a chip board-type board. In a complementary variation, one may then arrange on the chip board blocks of nuances to enable the usage of said board with a device enabling to read the board (virtual chart of colour range) or not (actual chart of colour range, with reading nuances performed by the reading head).

The mixer-dispenser is realised preferably in a light-diffusing material. The collection optical fibre, arranged at the end of the head is preferably a stick composed of an assembly of fibres isolated and separated optically and welded parallel together. Such a stick is, for example, produced by SCHOTT under the generic reference FST. This type of stick may also be curved by heat in case when it is desirable to have a curved end of the head. The stick may be protected by an outer sheath, notably a metal one. In a preferred embodiment, the collection stick or, even better, the front portion, towards the tooth, of the stick, may be removable in order to enable sterilisation of the part of the device which is effectively in contact with the tooth. With such a structure of stick-type collection fibre and which is removable, the use of a single-use clear cap may be omitted, the stick being sterilised between usage on different patients.

Different modifications may be brought to the device described above without departing from the framework of the invention. In particular:
The miniaturisation of the components enables to insert a large number of them in the measuring head. The light source may be a white light-emitting diode inserted in the head and the analyser may also be, totally or partially, carried by this very head.
The classification of the tooth is a comparison to references. One seeks to determine the reference with respect to which the tooth measured exhibits the smallest deviations.
The effect of the spurious light is advantageously neutralised by being taken into account before each measure.

1. A dental colorimetry measuring device including:
a white light source,
means enabling to project the luminous flux transmitted by the source on a tooth to be measured,
means for collecting the flux diffused by said tooth,
means of spectral selection of the flux diffused,
means for measuring luminous fluxes selected spectrally,
means for processing the result of these measures enabling classification of the tooth measured with respect to a chart of colour range, said device including a transmission and reception set and a measuring head contacting the tooth to be measured, the measuring head being connected to the transmission and reception set by an optical fibre beam,
characterised in that the measuring head includes an electric switch triggered by the pressure of the head on the tooth and controls the measure.

2. A dental colorimetry measuring device according to claim 1, characterised in that, at the end of the measuring head contacting the tooth, the transmission fibres are recessed with respect to the collection fibre.

3. A dental colorimetry measuring device according to any of the claims 1 and 2, characterised in that the measuring head is fitted with a single-use hygienic cap.

4. A dental colorimetry measuring device according to any of the claims 1 to 3, characterised in that the optical fibre beam includes a collection optical fibre at least partially of large diameter surrounded with small diameter transmission fibres.

5. A dental colorimetry measuring device according to any of the claims 1 to 4, characterised in that the collection optical fibre includes a large diameter mixer-dispenser.

6. A dental colorimetry measuring device according to claim 5, characterised in that selection fibres are coupled to the mixer and collect fluxes intended respectively for a measure of luminance and for each spectral measure.

7. A dental colorimetry measuring device according to any of the claims 1 to 6, characterised in that the spectral selection means are wide pass-band filters.

8. A dental colorimetry measuring device according to claim 7, characterised in that the filters are respectively yellow, blue, red and green.

9. A dental colorimetry measuring device according to any of the claims 1 to 8, characterised in that it includes calibration means measuring, for each measure of tooth, the fluxes selected spectrally, according to the same law as that applied to the light diffused, directly on the source and that the processing means make use of the spectral ratios composed, for each spectral selection, of the ratio of the measure of the flux diffused to that of the source.

10. A dental colorimetry measuring device according to any of the claims 1 to 9, characterised in that it includes means for assessing the luminosity including the measure of the luminosity of a gauge, the measure of the luminosity of the source when measuring the gauge, the measure of the luminosity of the tooth and the measure of the luminosity of the lamp when measuring the tooth.

11. A dental colorimetry measuring device according to any of the claims 1 to 10, characterised in that the chart of colour range is an actual chart of colour range whereof each tone has been measured prior to the measure of the tooth.

12. A dental colorimetry measuring device according to any of the claims 1 to 10, characterised in that the chart of colour range is a virtual chart of colour range.
